(19) United States
(12) Patent Application Publication
(10) Pub. No.: US 2013/0227383 A1
(43) Pub. Date: Aug. 29, 2013

(54) APPARATUS AND METHOD FOR SEARCHING FOR RESOURCES OF E-BOOK

(71) Applicant: Samsung Electronics Co., Ltd., (US)

(72) Inventor: Eun-Sun KIM, Yongin-si (KR)

(73) Assignee: SAMSUNG ELECTRONICS CO. LTD., Suwon-si (KR)

(21) Appl. No.: 13/759,287

(22) Filed: Feb. 5, 2013

(30) Foreign Application Priority Data
Feb. 23, 2012 (KR) 10-2012-0018266

(51) Int. Cl. G06F 17/30; G06F 17/27

(52) U.S. Cl. CPC G06F 17/30522; G06F 17/30241; G06F 17/27
USPC 715/201; 707/724; 707/609

(57) ABSTRACT

An apparatus and a method for searching for resources in an e-book are provided. The apparatus includes a memory having a resource-to-location mapping table in which information about resources of the e-book is mapped to location information that matches the resources of the e-book, and a controller for creating the resource-to-location mapping table and for controlling a search for a resource of the e-book that matches a location in the resource-to-location mapping table and a display of the detected resource of the e-book.

### PRIORITY

This application claims the benefit under 35 U.S.C. §119(a) of a Korean patent application filed in the Korean Intellectual Property Office on Feb. 23, 2012 and assigned Serial No. 10-2012-0018266, the entire disclosure of which is hereby incorporated by reference.

### BACKGROUND OF THE INVENTION

1. Field of the Invention

The present invention relates to an apparatus and method for searching for resources of an e-book. More particularly, the present invention relates to an apparatus and method for searching for a resource of an e-book that matches a location and displaying the detected resource.

2. Description of the Related Art

With the increasing popularity of smart phones and tablet Personal Computers (PCs), more and more e-book content is being used. An e-book content service of the related art simply displays content and provides a text-based search function.

The e-book content service of the related art has limitations in its effectiveness in utilizing location-based reality inherent to the nature of portable terminals capable of receiving Global Positioning System (GPS) information and providing convenient location-based functions.

For example, when a user carries a portable terminal including travel e-book content during a trip, the user has difficulty in searching for information that is relevant to a current location in the travel e-book content.

First of all, the user must know the name of the current location. Moreover, even though the user knows the name of the current location, only information that matches the name of the current location is detected. Therefore, the user faces limitations in searching the e-book content.

For example, if the user searches the e-book content using the keyword “Eiffel”, the user only receives results having the word “Eiffel”, but not information about the neighborhood around the Eiffel Tower. Accordingly, there is a need for an apparatus and method for searching for a resource of an e-book that matches a location and displaying the detected resource.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for searching for a resource of an e-book that matches a location and displaying the detected resource.

In accordance with an aspect of the present invention, an apparatus for searching for resources in an e-book is provided. The apparatus includes a memory having a resource-to-location mapping table in which information about resources of the e-book is mapped to location information that matches the resources of the e-book, and a controller for creating the resource-to-location mapping table, and for controlling a search for a resource of the e-book that matches a location in the resource-to-location mapping table and a display of the detected resource of the e-book.

In accordance with another aspect of the present invention, a method for searching for resources in an e-book is provided. The method includes creating a resource-to-location mapping table in which information about resources of the e-book is mapped to location information that matches the resources of the e-book, searching for a resource of the e-book that matches a location in the resource-to-location mapping table, and displaying the detected resource of the e-book.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIGS. 2A-2B illustrate a flowchart for creating a resource-to-location table for an e-book in a portable terminal according to an exemplary embodiment of the present invention; and

FIG. 3 illustrates a flowchart for searching for a resource of an e-book that matches a location in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

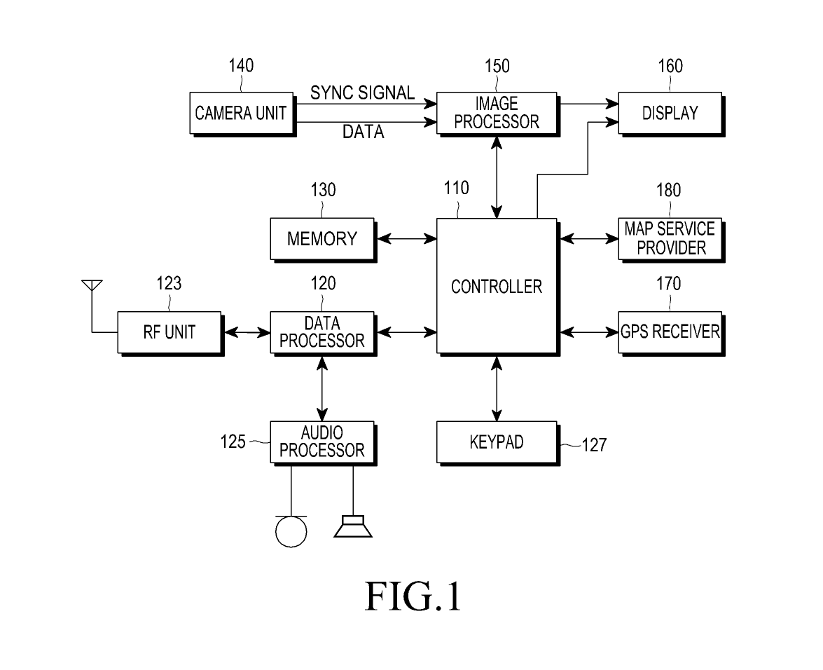

FIG. 1 is a block diagram of a portable terminal according to an exemplary embodiment of the present invention.

Referring to FIG. 1, a Radio Frequency (RF) unit 123 performs a wireless communication function for the portable terminal. The RF unit 123 includes an RF transmitter for upconverting the frequency of a transmission signal and amplifying the upconverted transmission signal and an RF receiver for low-noise-amplifying a received signal and downconverting the frequency of the low-noise-amplified signal. A data processor 120 includes a transmitter for encoding and modulating the transmission signal and a receiver for demodulating and decoding the received signal. That is, the data processor 120 may include a MODEM and a CODEC. The CODEC includes a data CODEC for processing packet data and an audio CODEC for processing an audio signal such as a voice. An audio processor 125 reproduces a received audio signal output from the audio CODEC of the data processor 120 or transmits a transmission audio signal generated from a microphone to the audio CODEC of the data processor 120.

A keypad 127 includes alphanumerical keys for inputting digits and characters and function keys for setting various functions.

A memory 130 may include a program memory and a data memory. The program memory may store programs required to control typical operations of the portable terminal and a program required for controlling a search operation for a resource of an e-book that matches a location and for controlling a display of the detected resource according to an exemplary embodiment of the present invention. In addition, the data memory temporarily stores data generated during execution of the programs.

In accordance with an exemplary embodiment of the present invention, the memory 130 stores a resource-to-location mapping table for each e-book stored in the portable terminal and the resource-to-location mapping table maps location information to resources of the e-book. In an exemplary embodiment of the present invention, the location information takes the form of Global Positioning System (GPS) coordinates which are latitude, longitude and altitude coordinates or latitude and longitude coordinates.

In accordance with an exemplary embodiment of the present invention, the resource-to-location mapping table may be configured as illustrated in Table 1 below.

TABLE 1

| Resource information | | |
|---|---|---|
| Starting resource | | |
| position in e-book | Resource type | Location information |
| Page 4, Line 10 | Image 2 | (x1, y1, z1) |
| Page 10, Lines 20-30 | Text 1 | (x2, y2, z2) |
| Page 20, Line 502 | Video 3 | (x3, y3, z3) |

In addition to location information per resource of the e-book, the resource-to-location mapping table may include information related to resources and information related to locations.

The resource-to-location mapping table may enable a quick search of resources that match locations based on classification of resources according to locations and may include information about the number of resources for each location.

A controller 110 provides overall control to the portable terminal.

In accordance with an exemplary embodiment of the present invention, the controller 110 creates a resource-to-location mapping table for each e-book, in which location information is mapped to e-book resources, and stores the resource-to-location mapping tables in the memory 130.

In accordance with an exemplary embodiment of the present invention, the controller 110 searches for resources of each e-book, searches for location information that matches the detected resources through a map service provider 180, and creates a resource-to-location mapping table including the location information mapped to the detected resources, for the e-book.

The resources of the e-book may include text, images, an audio, a video, and the like. In the case of text, the controller 110 searches for location information that matches the text through the map service provider 180. More specifically, the controller 110 extracts meaningful text from the e-book and searches for location information that matches the extracted text through the map service provider 180.

In the case of images, the controller 110 extracts location information that matches the images from geotagging information. In the case of an audio or video, the controller 110 searches for location information that matches information about the audio or video, stored in the title of a file of the audio and video or metadata of the audio and video through the map service provider 180.

In the absence of location information that matches a resource (text, audio, or video) in the map service provider 180, the controller 110 does not add information about the resource to the resource-to-location mapping table.

On the other hand, in the presence of location information that matches a resource (e.g., text, audio, or video) in the map service provider 180, the controller 110 provides the detected location information by latitude, longitude and altitude coordinates or latitude and longitude coordinates. If the controller 110 receives at least two pieces of location information (latitude, longitude and altitude coordinates and latitude and longitude coordinates) for a resource from the map service provider 180, the controller 110 maps all of the location information to information about the resource in the resource-to-location mapping table.

The controller 110 also stores information about the positions of resources in the e-book in the resource-to-location mapping table. The information about the positions of resources in the e-book is different from location information related to the resources on a map. That is, the former indicates the positions at which the resources are located within the e-book. The information about the positions of resources in the e-book may be represented in a different manner depending on a developer, a developing tool, a development method, and the like. For instance, the information about the positions of resources in the e-book may be stored as the starting positions (pages and lines) of the resources in the e-book.

If the font size of the e-book is changed according to current standard e-book regulations in a location-based e-book search mode, the controller 110 controls display of a resource by re-determining a page and a line corresponding to the stored starting position of the resource.

In accordance with an exemplary embodiment of the present invention, when a user requests or selects an “add” function regarding a resource-to-location mapping table while the resource-to-location mapping table is being displayed, the controller 110 searches for location information that matches user-selected resource information in an e-book corresponding to the resource-to-location mapping table and controls addition of the user-selected resource information and the detected location information that matches the user-selected resource information to the resource-to-location mapping table.

In accordance with an exemplary embodiment of the present invention, when a user requests or selects an “amend” function regarding a resource-to-location mapping table while the resource-to-location mapping table is being displayed, the controller 110 searches for location information that matches user-amended resource information in an e-book corresponding to the resource-to-location mapping table and controls storage of the user-amended resource information and the detected location information that matches the user-amended resource information in the resource-to-location mapping table.

In accordance with an exemplary embodiment of the present invention, when a user requests or selects a “delete” function regarding a resource-to-location mapping table, the controller 110 controls deletion of user-selected resource information and location information mapped to the user-selected resource information in the resource-to-location mapping table.

In accordance with an exemplary embodiment of the present invention, when a user selects resources in an e-book and selects location information that matches the resources in a map service, the controller 110 creates a resource-to-location mapping table by mapping the resources to the location information.

In accordance with an exemplary embodiment of the present invention, when a current location-based search is selected in a location-based e-book search mode, the controller 110 searches for a resource of the e-book that matches location information within a search radius around the current location of the portable terminal in a resource-to-location mapping table and controls display of the resource of the e-book.

In accordance with an exemplary embodiment of the present invention, when a location-based search is selected in the location-based e-book search mode, the controller 110 searches for a resource of an e-book that matches location information within a search radius around a user-selected location in a resource-to-location mapping table and controls display of the resource of the e-book.

In accordance with an exemplary embodiment of the present invention, the controller 110 first displays a resource labeled with a bookmark from among resources of an e-book detected from a resource-to-location mapping table.

In accordance with an exemplary embodiment of the present invention, the controller 110 indicates the presence of detected resources of an e-book on a map by indications, such as a flag or other marker. Upon selection of an indication indicating the presence of a resource from among the indications, the controller 110 controls to display a page of the e-book, which includes the resource corresponding to the indication.

A GPS receiver 170 provides information about the current location of the portable terminal. In accordance with an exemplary embodiment of the present invention, when a current location-based search is selected in the location-based e-book search mode, the GPS receiver 170 receives information about the current location of the portable terminal from GPS satellites and transmits the received current location information to the controller 110.

The map service provider 180 provides a map service along with map information and provides location information that matches resources of an e-book.

A camera unit 140 includes a camera sensor for capturing an image and converting the captured optical signal to an electrical signal and a signal processor for converting the analog image signal captured through the camera sensor to digital data. Herein, the camera sensor is assumed to be a Charge Coupled Device (CCD) or Complementary Metal Oxide Semiconductor (CMOS) sensor and the signal processor may be configured into a Digital Signal Processor (DSP). The camera sensor and the signal processor may be incorporated into a single device or separately configured.

An image processor 150 performs Image Signal Processing (ISP) to display an image signal received from the camera unit 140 on a display 160. The ISP involves functions such as gamma correction, interpolation, spatial change, image effects, image scaling, Auto White Balance (AWB), Auto Exposure (AE), Auto Focus (AF), etc. Therefore, the image processor 150 processes the image signal received from the camera unit 140 on a frame basis and outputs the frame image data according to the characteristics and size of the display 160. The image processor 150 includes a video CODEC for compressing frame image data to be displayed on the display 160 in a predetermined scheme or decompressing compressed frame image data to the original frame image data. The video CODEC may be a JPEG CODEC, an MPEG4 CODEC, a Wavelet CODEC, and the like. It is assumed herein that the image processor 150 is equipped with an On Screen Display (OSD) function, and the image processor 150 may output OSD data according to the size of a displayed screen under the control of the controller 110.

The display 160 displays the image signal received from the image processor 150 on a screen and also displays user data received from the controller 110. The display 160 may be configured with a Liquid Crystal Display (LCD). In this case, the display 160 may include an LCD controller, a memory for storing image data, and an LCD device. If the LCD is configured as a touch screen, it may serve as an input unit. Thus, the display 160 may display the same keys as those of the keypad 127 or may replace the key pad 127 altogether.

In accordance with an exemplary embodiment of the present invention, the display 160 displays a detected resource of an e-book that matches a location in the location-based e-book search mode.

In accordance with an exemplary embodiment of the present invention, the display 160 displays a list including information about detected resources of an e-book that matches location information and the location information mapped to the detected resources in the location-based e-book search mode.

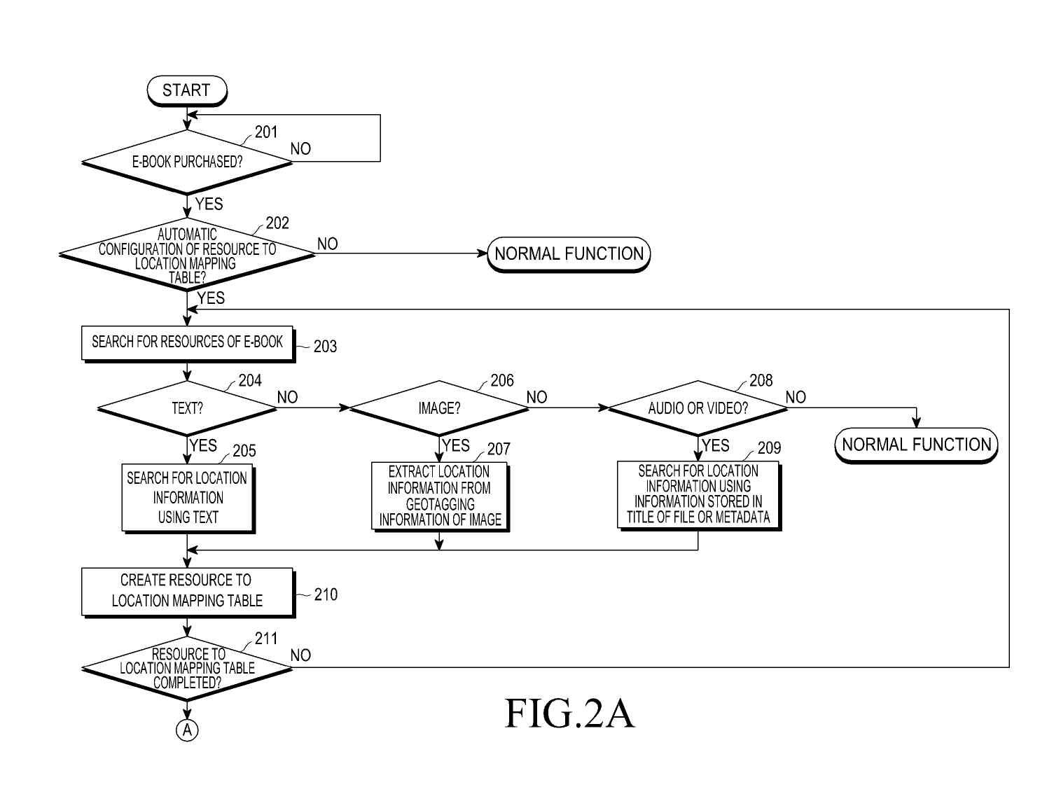

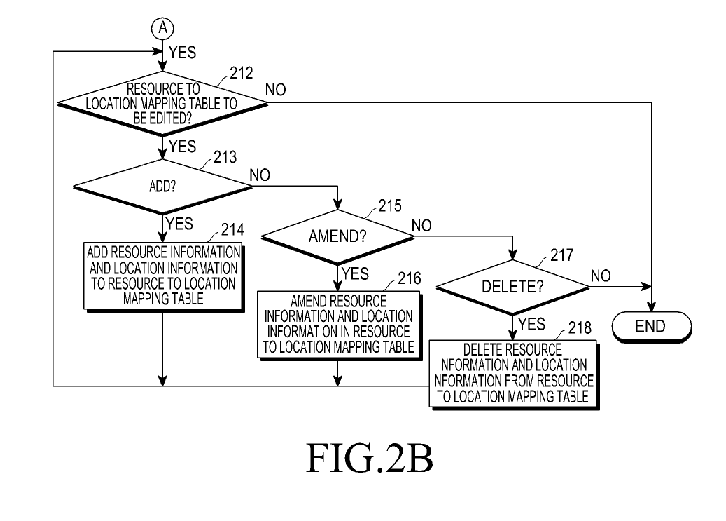

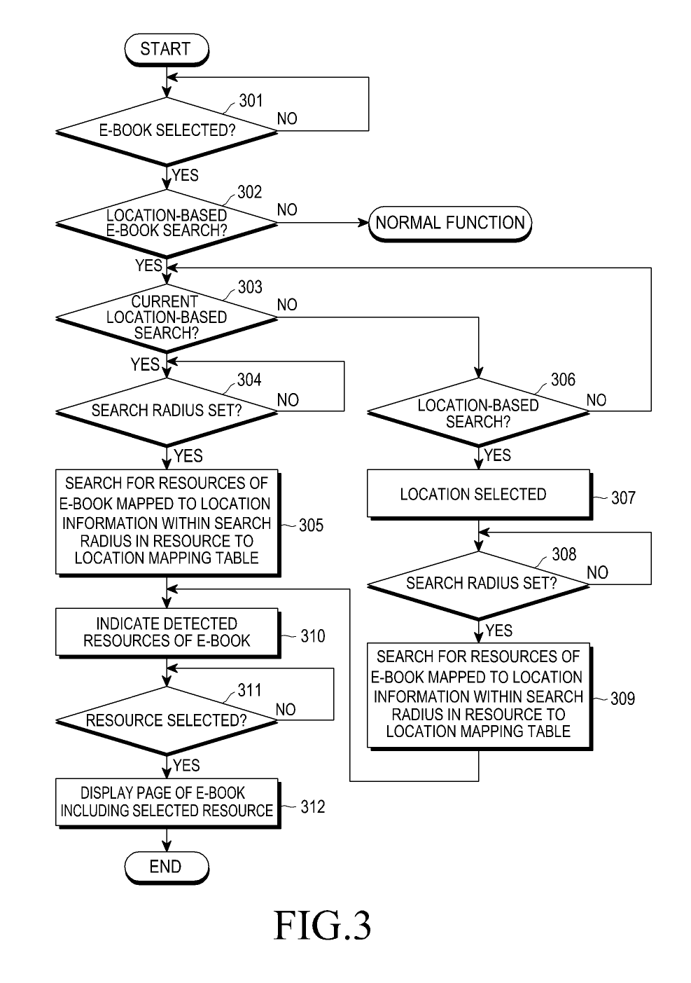

With reference to FIGS. 2A-2B and 3, an exemplary operation for creating a resource-to-location mapping table for an e-book in a portable terminal having the above-described configuration, searching for a resource of the e-book that matches a location in the resource-to-location mapping table, and displaying the detected resource will be described below.

FIGS. 2A-2B illustrate a flowchart for creating a resource-to-location table for an e-book in a portable terminal according to an exemplary embodiment of the present invention.

Referring to FIGS. 2A-2B, when a user purchases an e-book, the controller 110 senses the purchase of the e-book in step 201 and determines whether an automatic resource-to-location mapping table configuration function has been set in step 202. If the automatic resource-to-location mapping table configuration function has been set, the controller 110 goes to step 203. Otherwise, a normal function, other than the automatic resource-to-location mapping table configuration function, is performed.

In step 203, the controller 110 searches for a resource (e.g., a text, an image, an audio, a video, etc.) of the e-book. If determining that the detected resource is text in step 204, the controller 110 searches for location information that matches the text through the map service provider 180 in step 205.

If determining that the detected resource is an image in step 206, the controller 110 extracts location information that matches the image from geotagging information of the image in step 207.

If determining that the detected resource is an audio or video in step 208, the controller 110 searches for location information that matches the audio or video through the map service provider 180, using information stored in the title of a file of the audio or video or metadata of the audio or video in step 209.

Upon completely detecting location information that matches detected resources of the e-book in steps 204 through 209, the controller 110 creates a resource-to-location mapping table that maps the location information to information about the respective resources in step 210.

If the detected resource is a resource other than text, an image, an audio, or a video, and location information that matches the detected resource is detected in steps 204 through 209, the controller 110 may store the detected location information along with information about the detected resource in the resource-to-location mapping table.

If determining that the resource-to-location mapping table is yet to be completed in step 211, the controller 110 completes the resource-to-location mapping table for the e-book by repeating steps 203 through 210.

Upon completion of the resource-to-location mapping table for the e-book by repeating steps 203 through 210, the controller 110 finishes creating the resource-to-location mapping table. Thus, a user can determine the created resource-to-location mapping table or an already created resource-to-location mapping table for another e-book.

Upon selection of an editing function of the resource-to-location mapping table while the resource-to-location mapping table is being displayed in step 212, the controller 110 displays edit types.

Upon selection of an “add” function as an edit type in step 213, the controller 110 searches for location information that matches a user-selected resource of the e-book corresponding to the resource-to-location mapping table and adds information about the user-selected resource and the detected location information to the resource-to-location mapping table in step 214.

Upon selection of an “amend” function as an edit type in step 215, the controller 110 searches for location information mapped to user-amended resource information in the resource-to-location mapping table and stores the user-amended resource information and the detected location information in the resource-to-location mapping table in step 216.

Upon selection of a “delete” function as an edit type in step 217, the controller 110 deletes user-selected resource information and location information mapped to the user-selected resource information in the resource-to-location mapping table in step 218.

While the edit operation (e.g., add, amend, and delete) is described with reference to FIGS. 2A-2B as performed at the moment the resource-to-location mapping table is completed, it is to be understood that a user can select the editing function at any time and thus edit (e.g., add, amend, and delete) the resource-to-location mapping table.

Now a description will be given of an exemplary operation for searching for information about a resource of an e-book according to location information in a resource-to-location mapping table with reference to FIG. 3.

FIG. 3 illustrates a flowchart for searching for a resource of an e-book that matches a location in a portable terminal according to an exemplary embodiment of the present invention.

Referring to FIG. 3, when a user selects an e-book from among e-books stored in the portable terminal in step 301 and selects a location-based search for the selected e-book in step 302, the controller 110 awaits receipt of a search condition.

Upon selection of a current location-based search as a search condition in step 303, the controller 110 awaits receipt of a search radius input. When the user sets a search radius in step 304, the controller 110 searches for resources of the e-book that match information about locations within the search radius around the current location of the portable terminal in a resource-to-location mapping table for the e-book in step 305.

On the other hand, when the user selects a location-based search as a search condition in step 306 and selects a location in step 307, the controller 110 awaits receipt of a search radius input. When the user sets a search radius in step 308, the controller 110 searches for resources of the e-book that match information about locations within the search radius around the selected location in the resource-to-location mapping table in step 309. The user may select the location by entering the name or address of the location using text or on a map provided by the map service provider 180.

Upon detection of resources of the e-book that match the information about the locations within the search radius set around the current location of the portable terminal or the user-selected location in step 305 or 309, the controller 110 indicates the presence of detected resources on the display 160 in step 310.

In step 310, the controller 110 may indicate the presence of the detected resources of the e-book on a map. If there is a user-bookmarked resource among the detected resources of the e-book, the controller 110 indicates the presence of the bookmarked resource distinguishably from the other resources. In addition, the controller 110 may indicate the presence of the detected resources on the map in such a manner that the types of the detected resources are identified.

In step 310, the controller 110 may also display a list in which the location information is mapped to the detected resources of the e-book. If there is a user-bookmarked resource among the detected resources of the e-book, the controller 110 may list the bookmarked resource with a highest rank. In addition, the controller 110 may list the detected resources in the list in such a manner that the types of the detected resources are identified.

Upon selection of a resource from among the detected resources of the e-book on the display 160 in step 311, the controller 110 displays a page of the e-book including the selected resource in step 312.

Since resources of the e-book that match location information are indicated distinguishably, when a user selects a resource of the e-book while reading the e-book, location information that matches the selected resource may be displayed or indicated on a map. While reading the e-book, the user may amend location information that matches a selected resource. In the presence of a resource of the e-book to which location information is not mapped, the user may add location information that matches the resource.

In addition, as the portable terminal preserves location information per resource of an e-book, the exemplary resource search method of the present invention may be implemented in interaction with another service or may be extended to another service. For example, if a user selects a resource while reading an e-book, the user may plan a trip to a location that matches the selected resource by linking to a navigation service.

While configuration of a resource-to-location mapping table for an already written e-book has been described above, it may be further contemplated that a tool is made for creating a resource-to-location mapping table for an e-book and location information is stored per resource of the e-book using the tool in an early stage of writing the e-book.

As is apparent from the above description, with the apparatus and method for searching for resources of an e-book according to exemplary embodiments of the present invention, a user can readily access resources of an e-book according to location information and search for a resource of the e-book that matches a specific location without using many search keywords, simply by using the location and a search radius.

Exemplary embodiments of the present invention can also increase the utilization of a portable terminal equipped with an e-book service and a GPS receiver by interaction between the e-book service and a map service and thus can be extended to other services.

Furthermore, since the portable terminal already has content information corresponding to location information, the portable terminal has only to receive information about its current location from satellites over a network. Therefore, implementation is not expensive because data use is low.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for searching for resources in an e-book, the apparatus comprising:
a memory having a resource-to-location mapping table in which information about resources of the e-book is mapped to location information that matches the resources of the e-book; and
a controller for creating the resource-to-location mapping table and for controlling a search for a resource of the e-book that matches a location in the resource-to-location mapping table and a display of the detected resource of the e-book.

2. The apparatus of claim 1, further comprising a map service provider for providing the location information that matches the resources of the e-book and for providing a map service.

3. The apparatus of claim 1, wherein the controller creates a resource-to-location mapping table for each of a plurality of e-books stored in a portable terminal.

4. The apparatus of claim 1, wherein the controller automatically searches for the resources of the e-book, searches for the location information that matches the detected resources of the e-book, and creates the resource-to-location mapping table in which the information about the detected resources is mapped to the location information that matches the detected resources.

5. The apparatus of claim 4, wherein if a detected resource is text, the controller searches for location information that matches the text using the text, if the detected resource is an image, the controller searches for location information that matches the image in geotagging information, and if the detected resource is an audio or a video, the controller searches for location information that matches the audio or the video in a title of a file of the audio or the video or metadata of the audio or the video.

6. The apparatus of claim 1, wherein when an edit function is selected for the resource-to-location mapping table, the controller displays edit types and upon selection of an add function as an edit type, the controller adds user-added resource information and location information that matches the user-added resource information to the resource-to-location mapping table, upon selection of an amend function as an edit type, the controller amends user-selected resource information and location information mapped to the user-selected resource information in the resource-to-location mapping table, and upon selection of a delete function as an edit type, the controller deletes user-selected resource information and location information mapped to the user-selected resource information in the resource-to-location mapping table.

7. The apparatus of claim 1, wherein upon selection of a current location-based search function in a location-based e-book search mode, the controller searches for resource information that matches location information within a search radius set around a current location in the resource-to-location mapping table and displays a resource of the e-book corresponding to the resource information.

8. The apparatus of claim 1, wherein upon selection of a location-based search function in a location-based e-book search mode, the controller searches for resource information that matches location information within a search radius set around a selected location in the resource-to-location mapping table and displaying a resource of the e-book corresponding to the resource information.

9. The apparatus of claim 1, wherein when the controller searches for the resource of the e-book that matches the location and displays the detected resource of the e-book, the controller displays a book-marked resource with priority.

10. The apparatus of claim 1, wherein the controller indicates the presence of the detected resource of the e-book on a map by an indication and upon selection of the indication, the controller displays a page of the e-book including the detected resource.

11. The apparatus of claim 1, wherein the controller displays a list including information about the detected resource of the e-book and location information mapped to the information about the detected resource and upon selection of the resource in the list, the controller displays a page of the e-book including the selected resource.

12. A method for searching for resources in an e-book, the method comprising:
creating a resource-to-location mapping table in which information about resources of the e-book is mapped to location information that matches the resources of the e-book;
searching for a resource of the e-book that matches a location in the resource-to-location mapping table; and
displaying the detected resource of the e-book.

13. The method of claim 12, wherein the creating of the resource-to-location mapping table comprises creating a resource-to-location mapping table for each of a plurality of e-books stored in a portable terminal.

14. The method of claim 12, wherein the creating of the resource-to-location mapping table comprises:
searching for the resources of the e-book;
searching for the location information that matches the detected resources of the e-book; and
creating and storing the resource-to-location mapping table in which the information about the detected resources is mapped to the location information that matches the detected resources.

15. The method of claim 14, wherein the searching for the location information comprises:
searching for location information that matches text using the text, if a detected resource is the text;
searching for location information that matches an image in geotagging information, if the detected resource is the image; and
searching for location information that matches an audio or a video in a title of a file of the audio or the video or metadata of the audio or the video, if the detected resource is the audio or the video.

16. The method of claim 12, further comprising:
displaying edit types, upon selection of an edit function for the resource-to-location mapping table;
adding user-added resource information and location information that matches the user-added resource information to the resource-to-location mapping table, upon selection of an add function as an edit type;
amending user-selected resource information and location information mapped to the user-selected resource information in the resource-to-location mapping table, upon selection of an amend function as an edit type; and
deleting user-selected resource information and location information mapped to the user-selected resource information in the resource-to-location mapping table, upon selection of a delete function as an edit type.

17. The method of claim 12, wherein the displaying comprises:
searching for resource information that matches location information within a search radius set around a current location in the resource-to-location mapping table, upon selection of a current location-based search function in a location-based e-book search mode; and
displaying a resource of the e-book corresponding to the resource information.

18. The method of claim 12, wherein the displaying comprises:
searching for resource information that matches location information within a search radius set around a selected location in the resource-to-location mapping table, upon selection of a location-based search function in a location-based e-book search mode; and
displaying a resource of the e-book corresponding to the resource information.

19. The apparatus of claim 12, wherein the displaying comprises:
determining whether there is a bookmarked resource among detected resources of the e-book; and
displaying the book-marked resource with priority, in the presence of the book-marked resource.

20. The method of claim 12, wherein the displaying comprises:
indicating the presence of the detected resource of the e-book on a map by an indication; and
displaying a page of the e-book including the detected resource, upon selection of the indication.

21. The method of claim 12, wherein the displaying comprises:
displaying a list including information about the detected resource of the e-book and location information mapped to the information about the detected resource; and
displaying, upon selection of the resource in the list, a page of the e-book including the selected resource.
